(19) United States
(12) Patent Application Publication
(10) Pub. No.: US 2013/0207908 A1
(43) Pub. Date: Aug. 15, 2013

(54) CHOLESTERIC LIQUID CRYSTAL TOUCH DISPLAY PANEL AND TOUCH POSITIONING METHOD THEREOF

(71) Applicants: Ming-Tse Chang, Taipei City (TW); Chun-Wei Su, New Taipei City (TW)

(72) Inventors: Ming-Tse Chang, Taipei City (TW); Chun-Wei Su, New Taipei City (TW)

(21) Appl. No.: 13/471,465

(22) Filed: May 15, 2012

(30) Foreign Application Priority Data
Feb. 10, 2012 (TW) 101104314

(51) Int. Cl. G02F 1/133; G06F 3/041

(52) U.S. Cl. 345/173; 349/1

(57) ABSTRACT

A cholesteric liquid crystal touch display panel includes an upper substrate, a lower substrate, a cholesteric liquid crystal display layer, and a color sensor array. The cholesteric liquid crystal display layer is disposed between the upper substrate and the lower substrate. The cholesteric liquid crystal display layer includes a plurality of liquid crystal display units, which are used to reflect light within a wavelength range and allow light beyond the wavelength range to pass through. The color sensor array is disposed between the cholesteric liquid crystal display layer and the lower substrate. The color sensor array includes a plurality of color sensors. Each of the color sensors is disposed correspondingly to at least one liquid crystal display unit. Each of the color sensors is used to sense variations of light from the corresponding liquid crystal display unit.

### BACKGROUND OF THE INVENTION

1. Field of the Invention

The present invention relates to a cholesteric liquid crystal touch display panel and a touch positioning method thereof, and more particularly, to a cholesteric liquid crystal touch display panel having color sensors for sensing variations of light from liquid crystal display units and positioning touch points.

2. Description of the Prior Art

Compact designs and low power consumptions may be realized in reflective liquid crystal display devices because backlight units are not required for the reflective liquid crystal display. In recent years, electronic products such as electronic papers and tablet PCs, which employ reflective liquid crystal display panels, are commercialized. Among all kinds of liquid crystals, the cholesteric liquid crystal is suitable for the low power consumption reflective liquid crystal display device because the cholesteric liquid crystal may be employed to selectively reflect light within a wavelength range and allow light beyond the wavelength range to pass through, and the cholesteric liquid crystal may be kept in a bistable state when applied voltages are removed.

In addition, touch sensing technologies have developed flourishingly in recent years, and electronic products, which both have touch sensing and display functions, are commercialized accordingly. However conventional add-on touch panels have a negative influence on the aspects of weight, thickness, and display quality. Additionally, conventional capacitive touch panels have to be operated by conductive touching objects and their usability is limited accordingly. Therefore, related industries still work on integrating the functions and structures of the touch panel and of the display panel more effectively.

### SUMMARY OF THE INVENTION

It is one of the objectives of the present invention to provide a cholesteric liquid crystal touch display panel and a touch positioning method thereof. Color sensors are disposed under liquid crystal display units. The color sensors are employed to sense variations of light influenced by the liquid crystal display units when they are pressed by touch objects, and the touch positioning effect may then be obtained.

To achieve the purposes described above, a preferred embodiment of the present invention provides a cholesteric liquid crystal touch display panel. The cholesteric liquid crystal touch display panel includes an upper substrate, a lower substrate, a cholesteric liquid crystal display layer, and a color sensor array. The lower substrate is disposed correspondingly to the upper substrate. The cholesteric liquid crystal display layer is disposed between the upper substrate and the lower substrate. The cholesteric liquid crystal display layer includes a plurality of liquid crystal display units, and the liquid crystal display units are used to reflect light within a wavelength range and allow light beyond the wavelength range to pass through. The color sensor array is disposed between the cholesteric liquid crystal display layer and the lower substrate. The color sensor array includes a plurality of color sensors. Each of the color sensors is disposed correspondingly to at least one liquid crystal display unit. Each of the color sensors is used to sense variations of light from the corresponding liquid crystal display unit.

To achieve the purposes described above, a preferred embodiment of the present invention provides a touch positioning method of a cholesteric liquid crystal touch display panel. The touch positioning method of the cholesteric liquid crystal touch display panel includes the following steps. First of all, a cholesteric liquid crystal touch display panel is provided. The cholesteric liquid crystal touch display panel includes an upper substrate, a lower substrate, a cholesteric liquid crystal display layer, and a color sensor array. The lower substrate is disposed correspondingly to the upper substrate. The cholesteric liquid crystal display layer is disposed between the upper substrate and the lower substrate. The cholesteric liquid crystal display layer includes a plurality of liquid crystal display units, and the liquid crystal display units are used to reflect light within a wavelength range and allow light beyond the wavelength range to pass through. The color sensor array is disposed between the cholesteric liquid crystal display layer and the lower substrate. The color sensor array includes a plurality of color sensors. Each of the color sensors is disposed correspondingly to at least one liquid crystal display unit. Each of the color sensors is used to sense variations of light from the corresponding liquid crystal display unit. Each of the color sensors includes a converting device, and the converting device is used to convert the received light into output voltage. A display signal is inputted into the cholesteric liquid crystal display layer to present a display image, and the output voltage corresponding to the display image is obtained by the color sensors simultaneously. Variations of the output voltage from each of the color sensors are monitored to determine whether the cholesteric liquid crystal touch display panel is touched or not. The variations of the output voltage from each of the color sensors are calculated to define a touched region in the cholesteric liquid crystal touch display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-4 are schematic diagrams illustrating a cholesteric liquid crystal touch display panel according to a preferred embodiment of the present invention.

FIGS. 5-8 are schematic diagrams illustrating a cholesteric liquid crystal touch display panel according to another preferred embodiment of the present invention.

FIG. 9 is a flow chart illustrating a positioning method of a cholesteric liquid crystal touch display panel according to a preferred embodiment of the present invention.

FIG. 10 is a flow chart illustrating a positioning method of a cholesteric liquid crystal touch display panel according to another preferred embodiment of the present invention.

### DETAILED DESCRIPTION

Certain terms are used throughout the description and following claims to refer to particular components. As one skilled in the art will understand, electronic equipment manufacturers may refer to a component by different names. This document does not intend to distinguish components that differ in name but not function. In the following description and in the claims, the term “include” is used in an open-ended fashion, and thus should be interpreted to mean “include, but not limited to . . . ” In addition, to simplify the descriptions and make it more convenient to compare embodiments between each other, identical components are marked with the same reference numerals in each of the following embodiments. Please note that the figures are only for illustration and the figures may not be to scale. Additionally, the terms such as “first” and “second” in this context are only used to distinguish different components and do not constrain the order of generation.

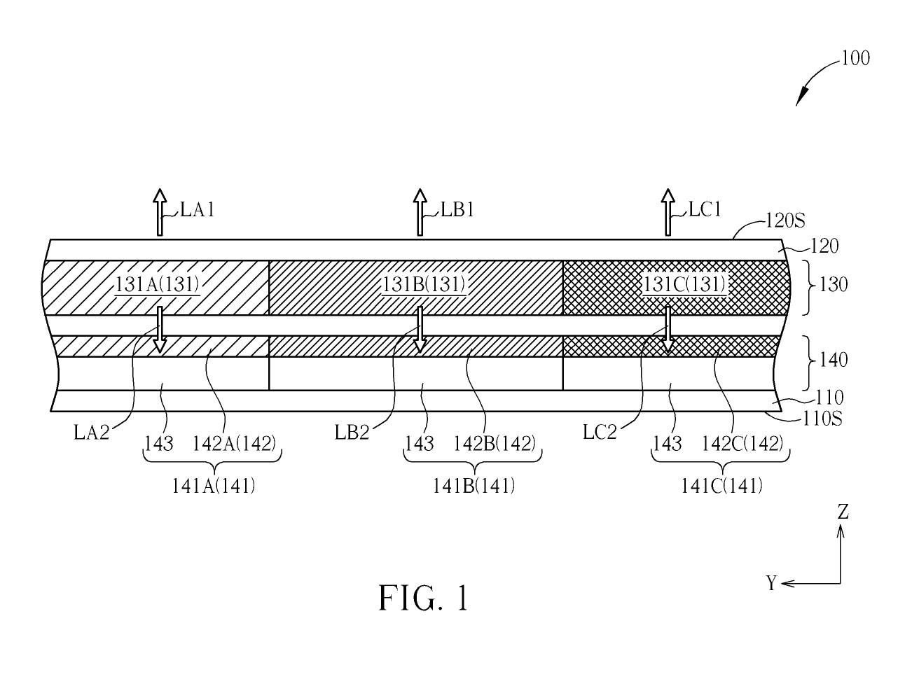

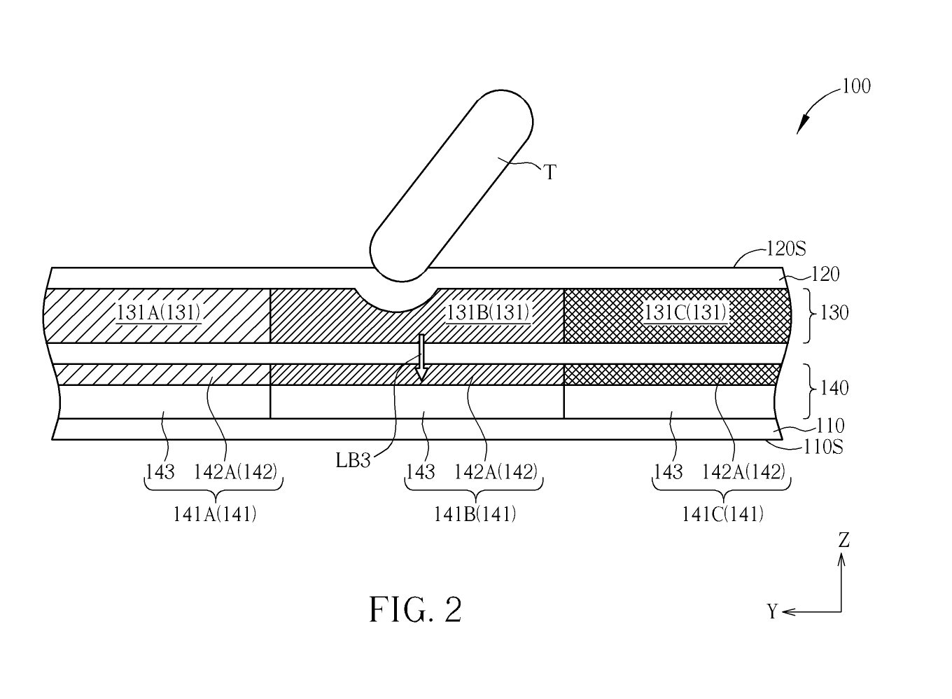

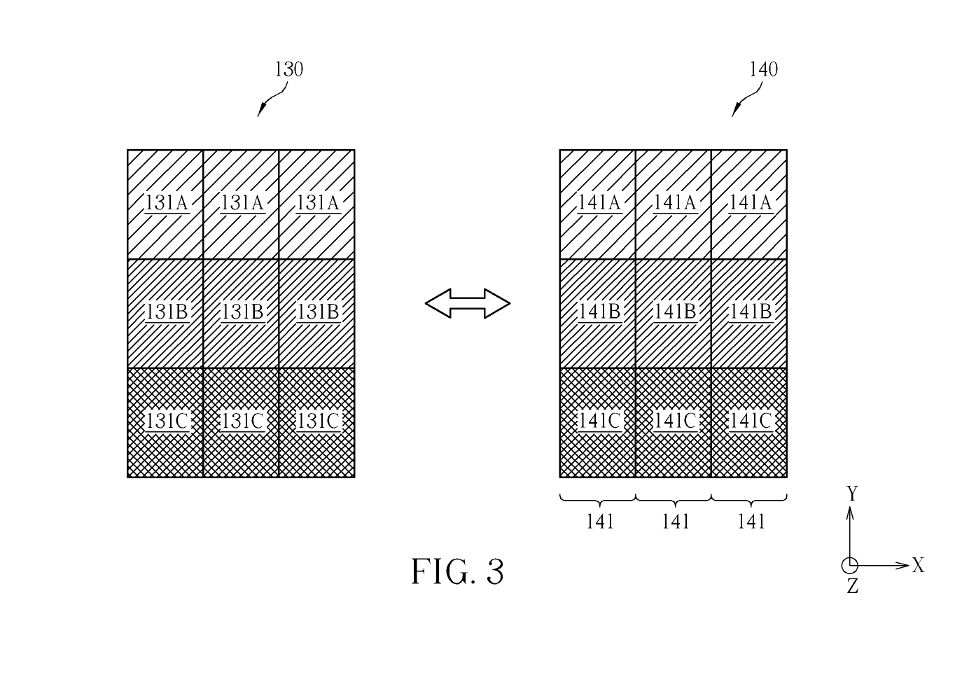

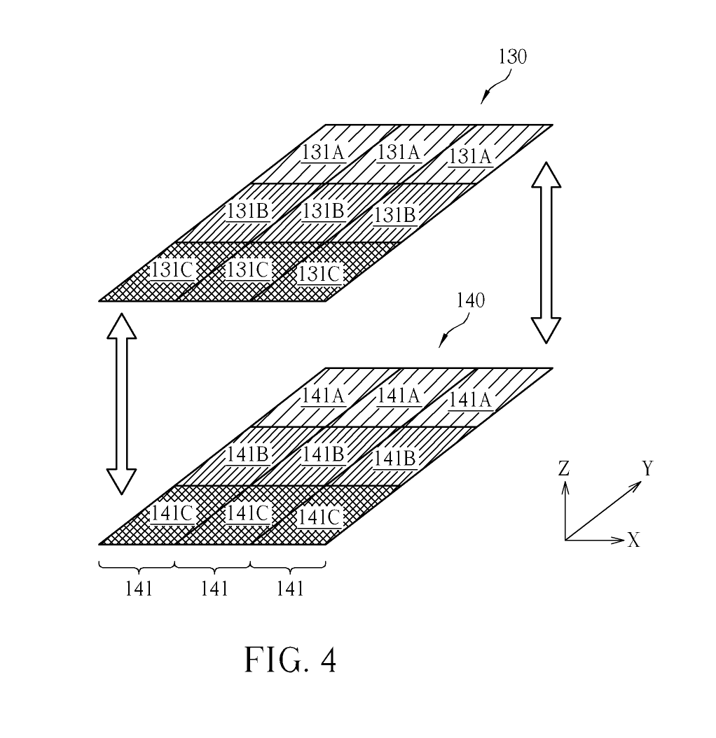

Please refer to FIGS. 1-4. FIGS. 1-4 are schematic diagrams illustrating a cholesteric liquid crystal touch display panel according to a preferred embodiment of the present invention. FIG. 2 is a schematic diagram illustrating the cholesteric liquid crystal touch display panel under operation. FIG. 3 and FIG. 4 are schematic diagrams illustrating a corresponding relation between a cholesteric liquid crystal display layer and a color sensor array. Please note that the figures are only for illustration and the figures may not be to scale. The scale may be further modified according to different design considerations. As shown in FIG. 1 and FIG. 3, the preferred embodiment of the present invention provides a cholesteric liquid crystal touch display panel 100. The cholesteric liquid crystal touch display panel 100 includes an upper substrate 120, a lower substrate 110, a cholesteric liquid crystal display layer 130, and a color sensor array 140. The lower substrate 110 is disposed correspondingly to the upper substrate 120. The upper substrate 120 preferably includes a flexible substrate, such as a plastic substrate and a glass substrate, or other substrates made of appropriate materials. The cholesteric liquid crystal display layer 130 is disposed between the upper substrate 120 and the lower substrate 110. Components of the cholesteric liquid crystal display layer 130 may preferably include cholesteric liquid crystal monomers, dyes, chiral reagents, or polymer mixtures, but not limited thereto. Additionally, the cholesteric liquid crystal display layer 130 includes a plurality of liquid crystal display units 131, and the liquid crystal display units 131 are used to reflect light within a wavelength range and allow light beyond the wavelength range to pass through. More specifically, the liquid crystal display units 131 in this embodiment are aligned in an array configuration, and the liquid crystal display units 131 include a first liquid crystal display unit 131A, a second liquid crystal display unit 131B, and a third liquid crystal display unit 131C. By modifying components of the first liquid crystal display unit 131A, the second liquid crystal display unit 131B, and the third liquid crystal display unit 131C, the first liquid crystal display unit 131A, the second liquid crystal display unit 131B, and the third liquid crystal display unit 131C may be employed to reflect light within different wavelength ranges of ambient light. For example, the first liquid crystal display unit 131A may be employed to generate reflected light LA1, the second liquid crystal display unit 131B may be employed to generate reflected light LB1, and the third liquid crystal display unit 131C may be employed to generate reflected light LC1. The reflected light LA1, the reflected light LB1, and the reflected light LC1 mentioned above may respectively be red light, green light, and blue light, but not limited thereto. The reflected light LA1, the reflected light LB1, and the reflected light LC1 may be mixed to generate a display image on a top surface 120S of the upper substrate 120 in the cholesteric liquid crystal touch display panel 100.

The color sensor array 140 is disposed between the cholesteric liquid crystal display layer 130 and the lower substrate 110. The color sensor array 140 includes a plurality of color sensors 141. Each of the color sensors 141 is disposed correspondingly to at least one liquid crystal display unit 131. Each of the color sensors 141 is used to sense variations of light of the corresponding liquid crystal display unit 131. In this embodiment, each of the color sensors 141 may preferably include a color filter 142 for sensing light within a specific wavelength range, but not limited thereto. For further description, each of the color sensors 141 in this embodiment may preferably include a first color sensor unit 141A, a second color sensor unit 141B, and a third color sensor unit 141C for respectively sensing light within different wavelength ranges. Additionally, the color filters 142 in this embodiment may include a first color filter 142A, a second color filter 142B, and a third color filter 142C of different colors. The first color filter 142A, the second color filter 142B, and the third color filter 142C are respectively disposed in the first color sensor unit 141A, the second color sensor unit 141B, and the third color sensor unit 141C. The first color sensor unit 141A, the second color sensor unit 141B, and the third color sensor unit 141C may be employed to sense light within different wavelength ranges accordingly.

For example, the first color filter 142A, the second color filter 142B, and the third color filter 142C may respectively be a red color filter, a green color filter, and a blue color filter. The first color sensor unit 141A, the second color sensor unit 141B, and the third color sensor unit 141C may be respectively employed to sense red light, green light, and blue light accordingly, but not limited thereto. Additionally, the first color sensor unit 141A, the second color sensor unit 141B, and the third color sensor unit 141C within one color sensor are respectively disposed correspondingly to three adjacent liquid crystal display units 131. Therefore, light LA2, light LB2, and light LC2 respectively received by the first color sensor unit 141A, the second color sensor unit 141B, and the third color sensor unit 141C may mainly include the light which is allowed to pass through the first liquid crystal display unit 131A, the second liquid crystal display unit 131B, and the third liquid crystal display unit 131C, but the present invention is not limited to this and in other preferred embodiments, the light LA2, the light LB2, and the light LC2 may also include the light reflected by the first liquid crystal display unit 131A, the second liquid crystal display unit 131B, and the third liquid crystal display unit 131C. For example, when the cholesteric liquid crystal touch display panel 100 is a transparent touch display panel, an ambient light from a bottom surface 110S of the lower substrate 110 may be reflected by the first liquid crystal display unit 131A, the second liquid crystal display unit 131B, and the third liquid crystal display unit 131C. The reflected light may then be received by the first color sensor unit 141A, the second color sensor unit 141B, and the third color sensor unit 141C. In other words, the light sensed by the color sensors 141 may include transmissive light or/and reflected light generated by the liquid crystal display units 131.

As shown in FIG. 1 and FIG. 2, when a touch object T presses the cholesteric liquid crystal touch display panel 100, the cholesteric liquid crystal display layer 130 is pressed and an alignment condition of liquid crystals in the cholesteric liquid crystal display layer 130 may be changed. The light received by the color sensor 141 may accordingly become different. Each of the color sensors 141 may be employed to sense variations of light from the corresponding liquid crystal display unit 131 for positioning a touch point. For example, when the touch object T presses the second liquid crystal display unit 131B, the alignment condition of the liquid crystals in the second liquid crystal display unit 131B is changed, and the light LB3 received by the second color sensor unit 141B at this moment will be different from the light LB2 without pressing. A wavelength range of the light LB3 is different from a wavelength range of the light LB2. Comparatively, the light received by the color sensors 141 on the other regions of the cholesteric liquid crystal touch display panel 100 without pressing from the touch object T may not be influenced. Accordingly, the light received by the color sensors 141 may be calculated to position the touch point. In addition, it is worth noting that the cholesteric liquid crystal touch display panel 100 in this embodiment has to be pressed for positioning touch points, and the touch positioning approach of the cholesteric liquid crystal touch display panel 100 may include a force sensing touch positioning approach, but not limited thereto. In other words, the touch object T suitable for the cholesteric liquid crystal touch display panel 100 may not be limited to conductive objects, and the usability of the cholesteric liquid crystal touch display panel 100 may be accordingly enhanced. Additionally, each of the color sensors 141 in this embodiment may preferably include a converting device 143, and the converting device 143 may be employed to convert received light into output voltage, but the present invention is not limited to this and other appropriate approaches may also be employed to handle and calculate the light received by the color sensors 141 to position the touch point.

As shown in FIG. 1, FIG. 3, and FIG. 4, in the cholesteric liquid crystal display layer 130, each of the first liquid crystal display units 131A, each of the second liquid crystal display units 131B, and each of the third liquid crystal display units 131C are alternately disposed along a second direction Y. The first liquid crystal display units 131A, the second liquid crystal display units 131B, and the third liquid crystal display units 131C are repeatedly disposed along a first direction X respectively. In other words, each of the second liquid crystal display units 131B is disposed adjacently to one first liquid crystal display unit 131A and one second liquid crystal display unit 131C along the second direction Y. Each of the first liquid crystal display units 131A is disposed adjacently to other first liquid crystal display units 131A along the first direction X, each of the second liquid crystal display units 131B is disposed adjacently to other second liquid crystal display units 131B along the first direction X, and each of the third liquid crystal display units 131C is disposed adjacently to other third liquid crystal display units 131C along the first direction X, but not limited thereto. Additionally, each of the first color sensor units 141A, each of the second color sensor units 141B, and each of the third color sensor units 141C are alternately disposed along the second direction Y. The first color sensor units 141A, the second color sensor units 141B, and the third color sensor units 141C are repeatedly disposed along the first direction X respectively. The liquid crystal display units 131 disposed correspondingly to the first color sensor unit 141A, the second color sensor unit 141B, and the third color sensor unit 141C within one color sensor 141 are used to reflect light within the different wavelength ranges. In other words, the first color sensor unit 141A, the second color sensor unit 141B, and the third color sensor unit 141C within one color sensor 141 are disposed correspondingly to one first liquid crystal display unit 131A, one second liquid crystal display unit 131B, and one third liquid crystal display unit 131C along a third direction Z perpendicular to the cholesteric liquid crystal touch display panel 100 respectively. According to the allocation approach described above, each of the liquid crystal display units 131 may be monitored by the color sensors 141, and the touch positioning accuracy of the cholesteric liquid crystal touch display panel 100 may be accordingly enhanced.

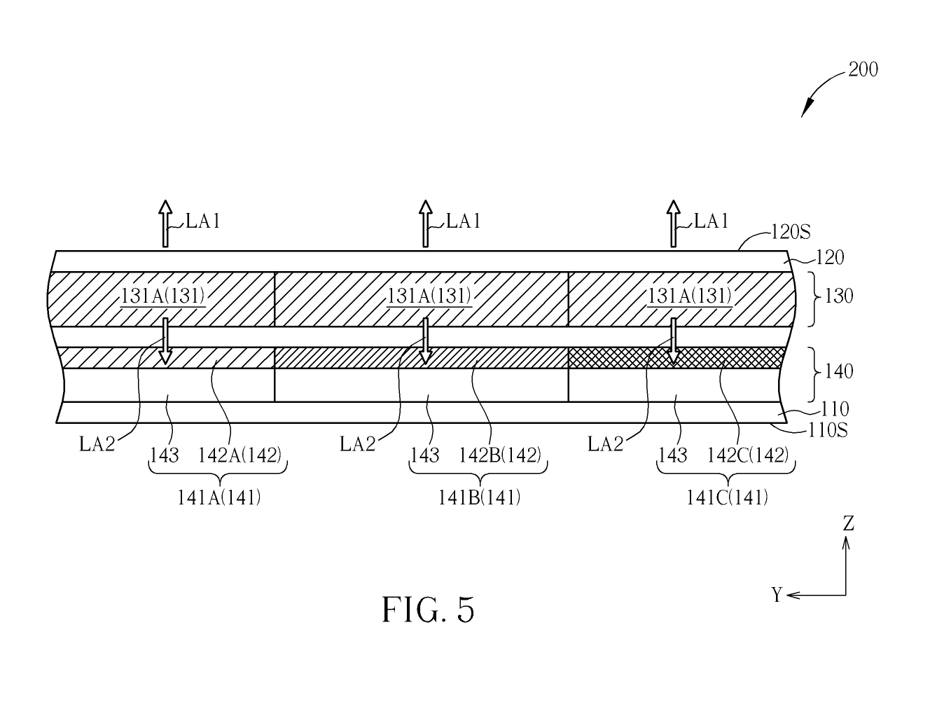

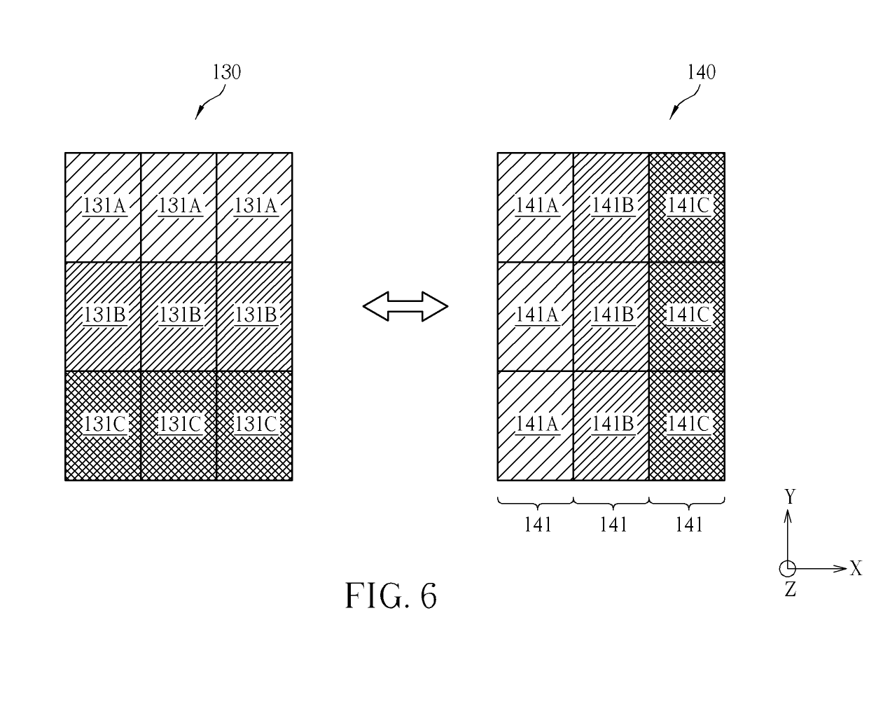

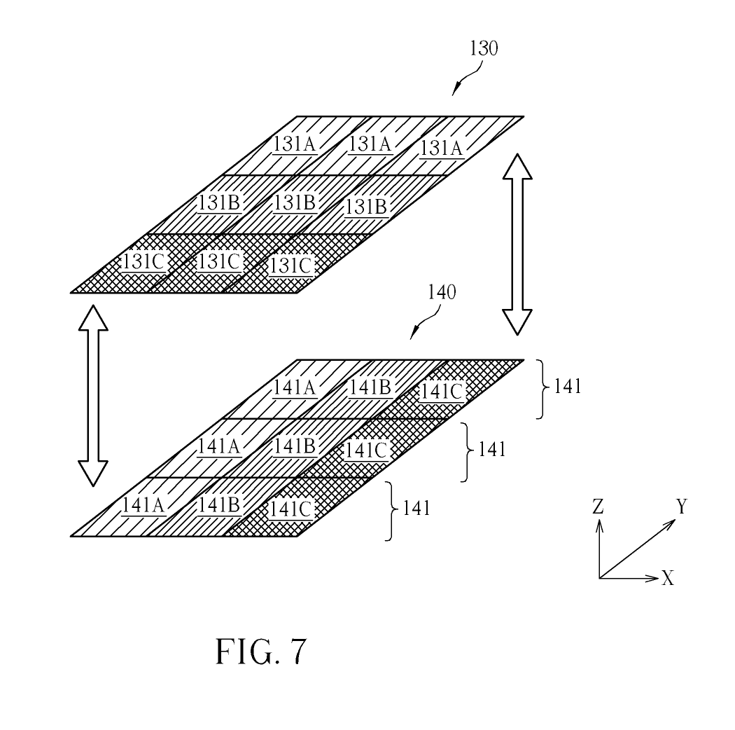

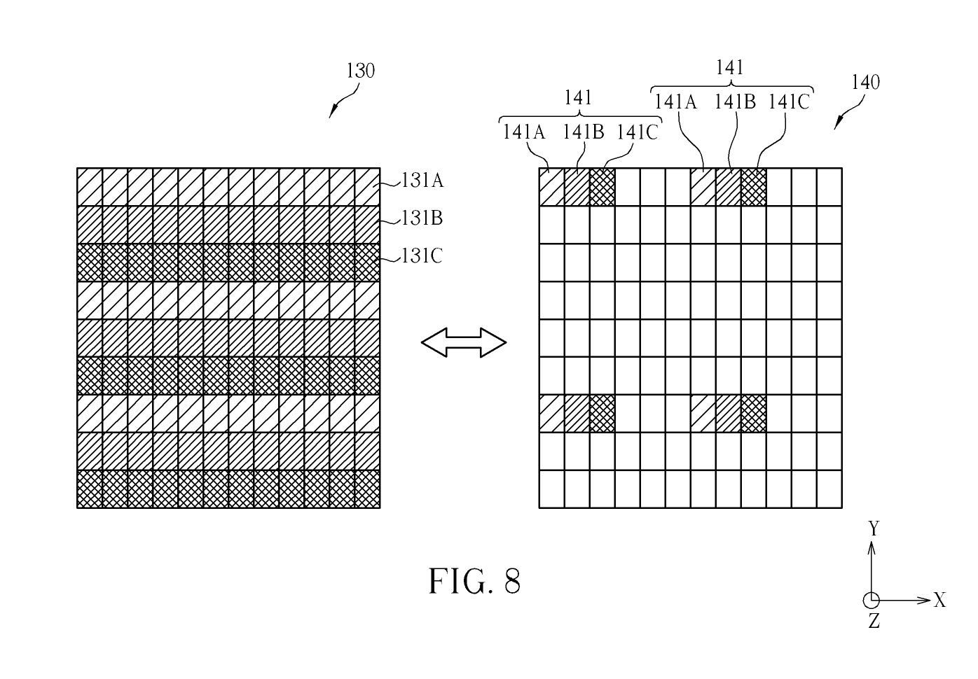

Please refer to FIGS. 5-8. FIGS. 5-8 are schematic diagrams illustrating a cholesteric liquid crystal touch display panel according to another preferred embodiment of the present invention. FIG. 6 and FIG. 7 are schematic diagrams illustrating a corresponding relation between a cholesteric liquid crystal display layer and a color sensor array in this embodiment. FIG. 8 is a schematic diagram illustrating a corresponding relation between a cholesteric liquid crystal display layer and a color sensor array in another exemplary embodiment. As shown in FIGS. 5-7, the difference between a cholesteric liquid crystal touch display panel 200 of this embodiment and the cholesteric liquid crystal touch display panel 100 detailed above is that in this embodiment, each of the first color sensor units 141A, each of the second color sensor units 141B, and each of the third color sensor units 141C are alternately disposed along the first direction X. The first color sensor units 141A, the second color sensor units 141B, and the third color sensor units 141C are repeatedly disposed along the second direction Y respectively. The liquid crystal display units 131 disposed correspondingly to the first color sensor unit 141A, the second color sensor unit 141B, and the third color sensor unit 141C within one color sensor 141 are used to reflect light within the same wavelength range. In other words, the first color sensor unit 141A, the second color sensor unit 141B, and the third color sensor unit 141C within one color sensor 141 may be disposed correspondingly to three adjacent first liquid crystal display units 131A along the third direction Z. The first color sensor unit 141A, the second color sensor unit 141B, and the third color sensor unit 141C within another color sensor 141 may be disposed correspondingly to three adjacent second liquid crystal display units 131B or three adjacent third liquid crystal display units 131C along the third direction Z.

According to the allocation approach detailed above, each of the liquid crystal display units 131 may be monitored by the color sensors 141, and the touch positioning accuracy of the cholesteric liquid crystal touch display panel 200 may be enhanced since the first color sensor units 141A, the second color sensor units 141B, and the third color sensor units 141C may receive light within different wavelength ranges. Apart from the corresponding relation between the cholesteric liquid crystal display layer 130 and the color sensor array 140 in this embodiment, the other components, allocations and material properties of this embodiment are similar to those of the cholesteric liquid crystal touch display panel 100 in the preferred embodiment detailed above, and will not be redundantly described. It is worth noting that, as shown in FIG. 8, the allocation condition of the color sensors 141 in the color sensor array 140 may be modified for different touch resolution requirements in another exemplary embodiment of the present invention. In other words, the color sensors 141 may be disposed correspondingly to only a part of the liquid crystal display units 131. The manufacturing cost and the complexity of the sensing calculation may be reduced with fewer color sensors 141. For example, the color sensors 141 may be disposed correspondingly to only a part of the first liquid crystal display units 131A to simplify the complexity of the sensing calculation without impacting the required touch resolution, but the present invention is not limited to this and the color sensors 141 may also be disposed correspondingly to only a part of the second liquid crystal display units 131B or only a part of the third liquid crystal display units 131C.

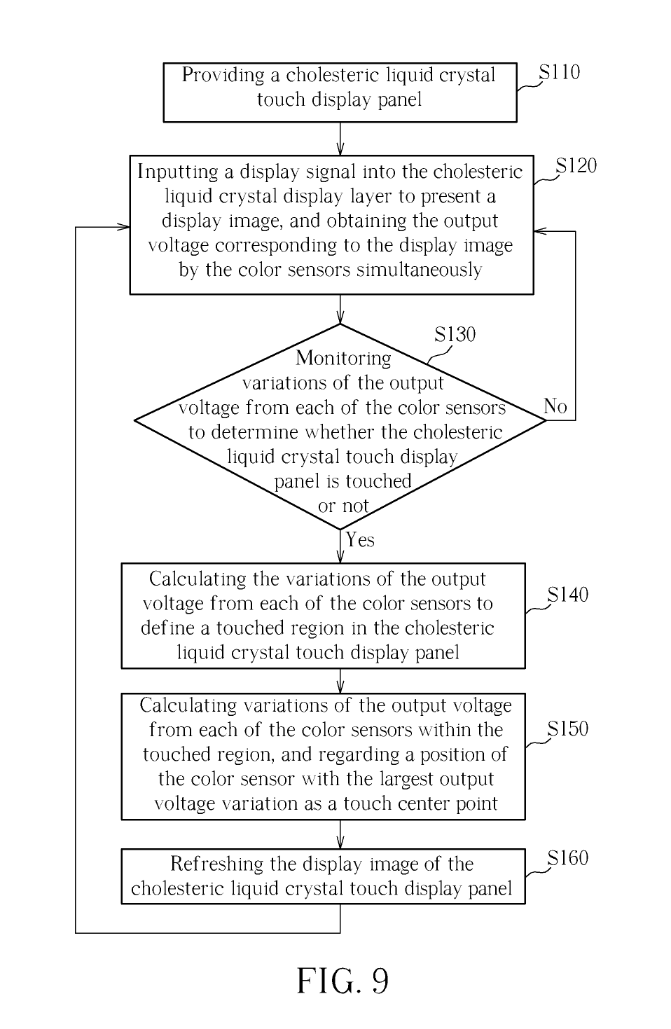

Please refer to FIG. 2, FIG. 4, and FIG. 9. FIG. 9 is a flow chart illustrating a touch positioning method of a cholesteric liquid crystal touch display panel according to a preferred embodiment of the present invention. As shown in FIG. 2, FIG. 4, and FIG. 9, the preferred embodiment of the present invention provides a touch positioning method of a cholesteric liquid crystal touch display panel. The touch positioning method of the cholesteric liquid crystal touch display panel includes the following steps. First of all, in step S110, a cholesteric liquid crystal touch display panel is provided. The cholesteric liquid crystal touch display panel may be the cholesteric liquid crystal touch display panel 100 or the cholesteric liquid crystal touch display panel 200 described above, and the components, allocations and material properties are detailed above and will not be redundantly described. Each of the color sensors 141 includes a converting device 143, and the converting device 143 is used to convert received light into output voltage. Subsequently, in step S120, a display signal is inputted into the cholesteric liquid crystal display layer 130 to present a display image, and the output voltage corresponding to the display image is obtained by the color sensors 141 simultaneously. In step S130, variations of the output voltage from each of the color sensors 141 are monitored to determine whether the cholesteric liquid crystal touch display panel 100 is touched or not. If the determination result is that the cholesteric liquid crystal touch display panel 100 is not touched, step S120 will be repeated so as to continually monitor the cholesteric liquid crystal touch display panel 100 by the color sensors 141 under the refreshment of display images. Additionally, if the determination result is that the cholesteric liquid crystal touch display panel 100 is touched, step S140 will be executed, and the variations of the output voltage from each of the color sensors 141 may be calculated to define a touched region in the cholesteric liquid crystal touch display panel 100.

In addition, the touch positioning method of the cholesteric liquid crystal touch display panel in this embodiment may further include a step S150 after the step S140. In step S150, the variations of the output voltage from each of the color sensors 141 within the touched region may be further calculated, and a position of the color sensor 141 with the largest output voltage variation may be regarded as a touch center point for enhancing the accuracy of the touch positioning result. Additionally, a step S160 may be executed after the step S150. In step S160, the display image of the cholesteric liquid crystal touch display panel is refreshed. The condition of the cholesteric liquid crystal touch display panel 100 may be continually monitored by the color sensors 141 after refreshing the display image. When a touch object presses the cholesteric liquid crystal touch display panel 100, the alignment condition of the liquid crystals in the liquid crystal display unit 131 is changed, and the light received by the color sensors 141 will become different. The color sensors 141 may be used to sense the variations of the light influenced by the corresponding liquid crystal display units 131 for positioning the touch points. It is worth noting that the accuracy of the touch positioning result may be enhanced by regarding the position of the color sensor 141 with the largest output voltage variation as the touch center point because the liquid crystal display units 131 corresponding to the pressed center point (which may also be referred as the touch center point) are generally pressed most seriously, and the variation of the light influenced by the liquid crystal display units 131 may be the largest one accordingly. For example, the output voltage from the color sensor 141 may become larger because the wavelength range of the light received by the color sensor will shift toward longer wavelengths when the liquid crystal display unit 131 is pressed with larger force. The variations of the output voltage from the color sensors 141 may be accordingly calculated and compared with each other.

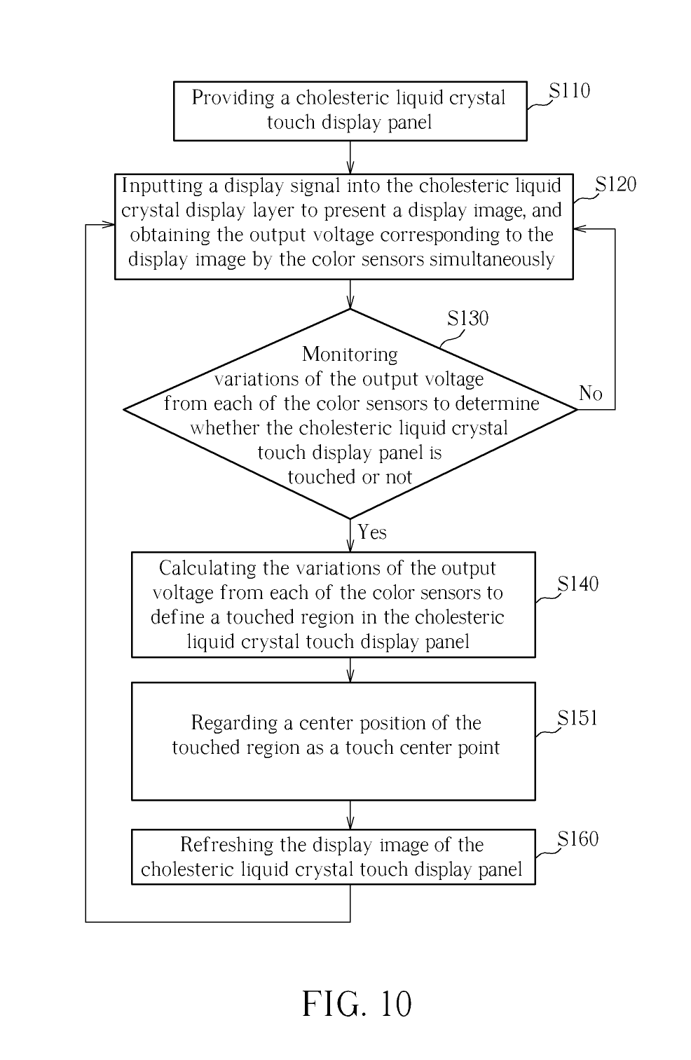

Please refer to FIG. 10. FIG. 10 is a flow chart illustrating a positioning method of a cholesteric liquid crystal touch display panel according to another preferred embodiment of the present invention. As shown in FIG. 10, the difference between the touch positioning method of the cholesteric liquid crystal touch display panel in this embodiment and the touch positioning method in the preferred embodiment detailed above is that a step S151 may be executed after the step S140 in the touch positioning method of the cholesteric liquid crystal touch display panel in this embodiment. In step S151, a center position of the touched region may be regarded as a touch center point for enhancing the accuracy of the touch positioning result. Apart from the approach to determine the touch center point, the other steps in the touch positioning method of the cholesteric liquid crystal touch display panel in this embodiment are similar to those of the touch positioning method of the cholesteric liquid crystal touch display panel in the preferred embodiment detailed above and will not be redundantly described.

To summarize the above descriptions, in the present invention, the color sensors are disposed under the liquid crystal display units. The liquid crystal display units are employed to display images, and the color sensors are employed to sense the light influenced by the liquid crystal display units which are pressed by the touch objects for performing the touch positioning function. Additionally, the accuracy of the touch positioning result may be further enhanced because the variation of the light influenced by the liquid crystal display units may become different with different forces pressing the liquid crystal display units.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cholesteric liquid crystal touch display panel, comprising:
an upper substrate;
a lower substrate, disposed correspondingly to the upper substrate;
a cholesteric liquid crystal display layer, disposed between the upper substrate and the lower substrate, wherein the cholesteric liquid crystal display layer comprises a plurality of liquid crystal display units, and the liquid crystal display units are used to reflect light within a wavelength range and allow light beyond the wavelength range to pass through; and
a color sensor array, disposed between the cholesteric liquid crystal display layer and the lower substrate, the color sensor array comprising a plurality of color sensors, wherein each of the color sensors is disposed correspondingly to at least one liquid crystal display unit, and each of the color sensors is used to sense variations of light from the corresponding liquid crystal display unit.

2. The cholesteric liquid crystal touch display panel of claim 1, wherein each of the color sensors comprises a color filter for sensing light within a specific wavelength range.

3. The cholesteric liquid crystal touch display panel of claim 1, wherein each of the color sensors comprises at least one first color sensor unit, at least one second color sensor unit, and at least one third color sensor unit for respectively sensing light within different wavelength ranges, and the first color sensor unit, the second color sensor unit, and the third color sensor unit within one color sensor are respectively disposed correspondingly to three adjacent liquid crystal display units.

4. The cholesteric liquid crystal touch display panel of claim 3, wherein the liquid crystal display units disposed correspondingly to the first color sensor unit, the second color sensor unit, and the third color sensor unit within one color sensor are used to reflect light within the same wavelength range.

5. The cholesteric liquid crystal touch display panel of claim 3, wherein the liquid crystal display units disposed correspondingly to the first color sensor unit, the second color sensor unit, and the third color sensor unit within one color sensor are used to reflect light within different wavelength ranges.

6. The cholesteric liquid crystal touch display panel of claim 1, wherein the liquid crystal display units are aligned in an array configuration, and the liquid crystal display units comprise at least one first liquid crystal display unit, at least one second liquid crystal display unit, and at least one third liquid crystal display unit for reflecting light within different wavelength ranges.

7. The cholesteric liquid crystal touch display panel of claim 1, wherein each of the color sensors further comprises a converting device, and the converting device is used to convert the received light into output voltage.

8. A touch positioning method of a cholesteric liquid crystal touch display panel, comprising:
providing the cholesteric liquid crystal touch display panel of claim 1, wherein each of the color sensors comprises a converting device, and the converting device is used to convert the received light into output voltage;
inputting a display signal into the cholesteric liquid crystal display layer to present a display image, and obtaining the output voltage corresponding to the display image by the color sensors simultaneously;
monitoring variations of the output voltage from each of the color sensors to determine whether the cholesteric liquid crystal touch display panel is touched or not; and
calculating the variations of the output voltage from each of the color sensors to define a touched region in the cholesteric liquid crystal touch display panel.

9. The touch positioning method of the cholesteric liquid crystal touch display panel of claim 8, further comprising:
calculating variations of the output voltage from each of the color sensors within the touched region; and
regarding a position of the color sensor with the largest output voltage variation as a touch center point.

10. The touch positioning method of the cholesteric liquid crystal touch display panel of claim 8, further comprising regarding a center position of the touched region as a touch center point.
